(19) United States
(12) Patent Application Publication
(10) Pub. No.: US 2009/0233151 A1
(43) Pub. Date: Sep. 17, 2009

(54) PROTON CONDUCTING OXIDIC ELECTROLYTE FOR INTERMEDIATE TEMPERATURE FUEL CELL

(76) Inventor: Masahiko Iijima, Saitama-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/300,478

(22) PCT Filed: May 23, 2007
(86) PCT No.: PCT/IB07/01331

§ 371 Date: Nov. 12, 2008

(30) Foreign Application Priority Data
May 29, 2006 (JP) 2006-148990

(51) Int. Cl. H01M 2/02; H01M 8/14

(52) U.S. Cl. 429/34; 429/46

(57) ABSTRACT

A fuel cell (100) is provided that includes a hydrogen separation membrane (10), an electrolyte membrane (20), provided on the hydrogen separation membrane, that has a proton conductivity and includes a perovskite type electrolyte having a A₁₋ₓA′ₓB_{1-y-z}B′_{y}B″_{z}O₃ structure, and a cathode (30) provided on the electrolyte membrane. The tolerance factor T of the perovskite type electrolyte satisfies 0.940≦T≦0.996.

### BACKGROUND OF THE INVENTION

1. Field of the Invention

The present invention relates to a fuel cell.

2. Description of the Related Art

Generally, a fuel cell uses hydrogen and oxygen as fuels and obtains electric energy. Because the fuel cell is environmentally excellent and attains high energy efficiency, the development of the fuel cell is advanced widely and extensively as a future energy supply system.

One type of fuel cell includes a solid oxide electrolyte as a mixed ion conductor, which is a mixture of protons and oxide ions. The solid oxide electrolyte provides good mixed ion conductivity, and therefore is widely used. A BaCeO₃ system perovskite type electrolyte is an example of the solid oxide electrolyte. To improve the chemical stability of the BaCeO₃ system perovskite, a technology is published in which Zr, Ti, or the like substitutes at a portion of Ce cites (See, for example, Japanese Patent Application Publication No. 2000-302550 (JP-A-2000-302550)).

The fuel cell using the solid oxide electrolyte includes a hydrogen separation membrane fuel cell. Here, the hydrogen separation membrane fuel cell means a fuel cell having a densified hydrogen separation membrane. The densified hydrogen separation membrane is a layer formed of a hydrogen permeable metal, and functions as an anode. The hydrogen separation membrane fuel cell includes a proton conducting electrolyte laminated on the hydrogen separation membrane. Hydrogen supplied to the hydrogen separation membrane is converted into protons, moves in the proton-conducting electrolyte, and is combined with oxygen in the cathode to generate electricity.

When the electricity is generated using the solid oxide electrolyte in accordance with the above-described JP-A-2000-302550, water is produced in the anode. Accordingly, if the solid oxide electrolyte described in the JP-A-2000-302550 is used, the water produced at the interface between the hydrogen separation membrane and the electrolyte membrane may cause deterioration of membranes, such as delamination of the hydrogen separation membrane from the electrolyte membrane.

### SUMMARY OF THE INVENTION

The present invention provides a fuel cell that includes an electrolyte with a good proton conductivity and a good chemical stability.

In one aspect of the present invention, a fuel cell is provided including a hydrogen separation membrane; an electrolyte membrane, provided on the hydrogen separation membrane, that has a proton conductivity and includes a perovskite type electrolyte having a A₁₋ₓA′ₓB_{1-y-z}B′_{y}B″_{z}O₃ structure; and a cathode provided on the electrolyte membrane. The tolerance factor T of the perovskite type electrolyte satisfies 0.940≦T≦0.996.

According to the above fuel cell, the electrolyte membrane is a proton-conducting electrolyte, instead of a mixed ion conductor. Therefore, water is not produced in the anode. Accordingly, delamination of the hydrogen separation membrane from the electrolyte membrane due to the water produced by electricity generation is suppressed. Further, because the tolerance factor T of the perovskite type electrolyte, which forms the electrolyte membrane, is close to one (1), stress arising from distortion in the crystal of the electrolyte membrane is reduced. Therefore, occurrence of crack in the electrolyte membrane and the delamination between the electrolyte membrane and the hydrogen separation membrane are suppressed. Further, reduction in the distortion in the crystal improves the crystal stability of the electrolyte membrane, thereby improving the hydrothermal stability. As a result, the deterioration in the electricity generation efficiency of the fuel cell is suppressed. Further, because the tolerance factor T is equal to or lower than 0.996, the electrolyte membrane can tolerate some degrees of distortion. In this case, the proton-conducting path is shortened in the electrolyte membrane. Therefore, the proton conductivity of the electrolyte membrane improves. Accordingly, the electricity generation efficiency of the fuel cell also improves.

The initial performance value may be equal to or higher than 0.40 A/cm². The initial performance value is a current density when the power voltage is equal to 0.5V at an initial stage of electricity generation of the fuel cell. It is generally known that the energy density of a solid oxide fuel cell is about 0.2 W/cm². In this case, the initial performance value of the solid oxide fuel cell can be calculated as 0.40 A/cm². Accordingly, the fuel cell having the initial performance value equal to or higher than 0.40 A/cm² has better electricity generation efficiency, as compared with the solid oxide fuel cell.

The operating temperature may be equal to or higher than 300° C. and is equal to or lower than 600° C. Because the hydrothermal decomposition is an exothermal reaction, the reaction proceeds faster in the temperature range from 300° C. to 600° C., as compared with the higher temperature range. Accordingly, the above-described electrolyte membrane having an excellent hydrothermal stability produces a particular effect in the fuel cell operating in the temperature range between 300° C. and 600° C.

The above-described “A” may be barium, and “B” may be cerium, because the BaCeO₃ system electrolyte has a high proton conductivity. However, because the BaCeO₃ system electrolyte is hydrothermally decomposed easily, the tolerance factor T must be set within a prescribed range to suppress the hydrothermal decomposition of the BaCeO₃ system electrolyte. Thus, when the electrolyte membrane formed of the BaCeO₃ system electrolyte is used, a particular effect is produced.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic cross-sectional view illustrating a fuel cell according to an exemplary embodiment of the present invention.

FIG. 2 is a diagram illustrating a relationship between tolerance factors T and initial performance values.

### DETAILED DESCRIPTION OF THE EXEMPLARY EMBODIMENTS

An exemplary embodiment of the present invention will be described below.

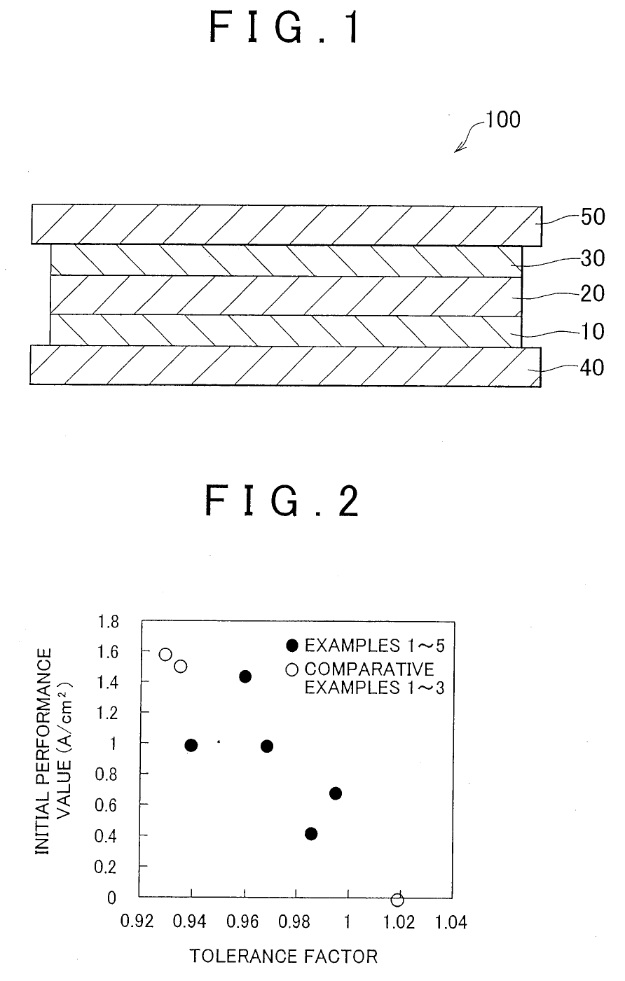

FIG. 1 is a schematic cross-sectional view illustrating a fuel cell 100 according to an exemplary embodiment of the present invention. As shown in FIG. 1, the fuel cell 100 includes a generation portion interposed between the separators 40 and 50. The generation portion includes an electrolyte membrane 20 and a cathode 30 laminated in this order on a hydrogen separation membrane 10. In the exemplary embodiment, the explanation will be made with respect to the unit cell as shown in FIG. 1. However, an actual fuel cell includes multiple unit cells stacked on each other. In the exemplary embodiment, the operating temperature of the fuel cell 100 is between about 300° C. and 600° C.

The separators 40 and 50 are made of a conductive material, such as stainless steel. A gas passage through which fuel gas including hydrogen flows is formed in the separator 40. A gas passage through which oxidant gas including oxygen flows is formed in the separator 50.

The hydrogen separation membrane 10 is made of a hydrogen permeable metal. The hydrogen separation membrane 10 functions as an anode through which the fuel gas is supplied, and also functions as a support member that supports and reinforces the electrolyte membrane 20. The hydrogen separation membrane 10 may be formed of a metal, such as, palladium, vanadium, titanium, tantalum, or the like. The film thickness of the hydrogen separation membrane 10 is, for example, about 3 μm-50 μm. The cathode 30 may be made of a conductive material, such as La_{0.6}Sr_{0.4}CoO₃, Sm_{0.5}Sr_{0.5}CoO₃, or the like. Further, the material forming the cathode 30 may carry a catalyst, such as platinum.

The electrolyte membrane 20 is a perovskite type proton-conducting electrolyte having a structure of A₍₁₋ₓ₎A′ₓB_{(1-y-z)}B′_{y}B″_{z}O₃. In other words, the perovskite has a structure in which A′ substitutes at a portion of A sites, and B′ and/or B″ substitute(s) at a portion of B sites. A′ does not always need to substitute at the A sites. Here, x, y and z respectively satisfy 0≦x≦1, 0≦y≦1, and 0≦z≦1. The A site is a divalent metal. The A′ is a metal having the valence of two or less. The B site is a quadrivalent metal. The B′ and B″ are metals having the valence of four or less.

The ion radii of A, A′, B, B′ and B″ are respectively denoted by R(A), R(A′), R(B), R(B′) and R(B″). The radius of oxygen ion O²⁻ is denoted by R(O). In this case, the tolerance factor T can be expressed by the following equation (1). Here, R(A) and R(A′) are the radii of ions that occupy the twelve-coordinated “A” sites, and R(B), R(B′), R(B″) and R(O) are the radii of ions that occupy the six-coordinated “B” sites.

T={R(A)·(1−x)+R(A′)·x+R(O)}/\sqrt{2}{R(B)·(1−y−z)+R(B′)·y+R(B″)·z+R(O)} (1)

Further, in the exemplary embodiment, the tolerance factor T needs to satisfy the following expression (2).

0.940≦T≦0.996 (2)

For example, Ba, Sr, or the like may be used as the A-site. Zr, Ce, or the like may be used as the B-site. Further, Zr, Y, In, or the like may be used as the B′ and B″, for example. Specific examples of the perovskite includes, for example, SrZr_{0.8}In_{0.2}O₃, BaCe_{0.4}Zr_{0.4}Y_{0.2}O₃, BaCe_{0.4}Zr_{0.4}In_{0.2}O₃, BaZr_{0.8}Y_{0.2}O₃, BaZr_{0.8}In_{0.2}O₃, or the like.

Next, the operation of the fuel cell 100 will be explained. Fuel gas including hydrogen is supplied from the gas passage in the separator 40 to the hydrogen separation membrane 10. Hydrogen included in the fuel gas dissociates into protons and electrons in the hydrogen separation membrane 10. The protons are conducted through the electrolyte membrane 20 to the cathode 30. Oxidant gas including oxygen is supplied from the gas passage in the separator 50 to the cathode 30. Water is produced from the oxygen included in the oxidant gas and the protons that reach the cathode 30, and electric power is generated. According to the operation described above, the fuel cell generates electricity.

In the exemplary embodiment, because the electrolyte membrane 20 is a proton-conducting electrolyte, instead of a mixed ion conductor, water is not produced in the anode. Accordingly, delamination between the hydrogen separation membrane 10 and the electrolyte membrane 20 caused by the water that is produced when the electricity is generated can be suppressed. Further, because the perovskite type electrolyte forming the electrolyte membrane 20 has the tolerance factor T that is close to 1, the distortion in the crystal of the electrolyte membrane 20 is reduced. In this case, the stress due to the distortion in the crystal is reduced. Therefore, occurrence of crack in the electrolyte membrane 20 and the delamination between the electrolyte membrane 20 and the hydrogen separation membrane 10 can be suppressed. Further, reduction in distortion in the crystal improves the crystal stability of the electrolyte membrane 20. Accordingly, the hydrothermal stability of the electrolyte membrane 20 improves. As a result, deterioration in the electricity generation efficiency of the fuel cell 100 can be suppressed.

Further, because the tolerance factor T is equal to or below 0.996, the electrolyte membrane 20 can tolerate some degrees of distortion. In this case, the proton-conducting path is shortened in the electrolyte membrane 20. Therefore, the proton conductivity of the electrolyte membrane 20 improves. As a result, the initial performance value of the fuel cell 100 can be equal to or higher than 0.4 A/cm². The initial performance value is a current density when the power generation voltage is equal to 0.5V at the initial stage of electricity generation. Here, it is generally known that the energy density of a conventional solid oxide fuel cell (SOFC) is about 0.2 W/cm². In this case, the initial performance value of the SOFC can be calculated (derived) as 0.40 A/cm² from the following equation (3). Accordingly, the fuel cell having the initial performance value equal to or higher than 0.40 A/cm² has better electricity generation efficiency, as compared with the SOFC.

2 W/cm²=0.5V×0.4 A/cm² (3)

As described above, by setting the tolerance factor T within the range satisfying the above-described expression (2), the chemical stability of the electrolyte 20 improves. Accordingly, the high electricity generation efficiency of the fuel cell 100 can be achieved.

Further, because the hydrothermal decomposition is an exothermic reaction, the reaction proceeds faster in the temperature range from 300° C. to 600° C., as compared with the higher temperature range. Accordingly, the above-described electrolyte membrane 20 having an excellent hydrothermal stability produces a particularly effect when used in the fuel cell.

Furthermore, preferably, the perovskite type electrolyte forming the electrolyte membrane 20 is a BaCeO₃ system material. This is because the BaCeO₃ system electrolyte has a high proton conductivity. However, because the BaCeO₃ system electrolyte is hydrothermally decomposed easily, the tolerance factor T must be set within a prescribed range to suppress the hydrothermal decomposition of the BaCeO₃ system electrolyte. Accordingly, when the electrolyte membrane formed of the BaCeO₃ system electrolyte is used, a particular effect is produced.

The fuel cell according to the exemplary embodiment was prepared and the characteristic thereof was evaluated, as follows.

In the examples 1 to 5, the fuel cells 100 according to the above-described exemplary embodiment were prepared. The hydrogen separation membrane 10 was formed from 100% palladium (Pd), and had an 80 μm film thickness. The electrolyte membrane 20 according to the example 1 was made of SrZr_{0.8}In_{0.2}O₃. The electrolyte membrane 20 according to the example 2 was made of BaCe_{0.4}Zr_{0.4}Y_{0.2}O₃. The electrolyte membrane 20 of the example 3 was made of BaCe_{0.4}Zr_{0.4}In_{0.2}O₃. The electrolyte membrane 20 of the example 4 was made of BaZr_{0.8}Y_{0.2}O₃. The electrolyte membrane 20 of the example 5 was made of BaZr_{0.8}In_{0.2}O₃. The film thickness of the electrolyte membrane 20 of each example was set to 2 μm. The cathode 30 was made of La_{0.6}Sr_{0.4}CoO₃, and had a 30 μm film thickness.

In the comparative examples 1 to 3, fuel cells having the lamination structure similar to that of the fuel cell 100 according to the above-described exemplary embodiment were prepared. The hydrogen separation membrane was formed from 100% Pd and had an 80 μm film thickness. The electrolyte membrane of the comparative example 1 was made of BaCe_{0.8}Nd_{0.2}O₃. The electrolyte membrane of the comparative example 2 was made of BaCe_{0.8}Y_{0.2}O₃. The electrolyte membrane of the comparative example 3 was made of BaZr_{0.8}Ni_{0.2}O₃. The cathode was made of La_{0.6}Sr_{0.4}CoO₃, and had a 30 μm film thickness.

The fuel cells 100 of the examples 1 to 5 and the fuel cells of the comparative examples 1 to 3 were evaluated with respect to the initial performance values and the presence/absence of the hydrothermal decomposition when the electricity was continuously generated in 500° C. With respect to the presence/absence of the hydrothermal decomposition, the cross-section of the electrolyte membrane was observed with the use of a transmission electron microscope (TEM) to detect whether hydroxide was formed. Whether the hydroxide was formed was determined based on whether a shear of the composition existed. FIG. 2 and Table 1 show the result. FIG. 2 is a diagram illustrating a relationship between tolerance factors T and initial performance values. In FIG. 2, the vertical line is the initial performance value and the horizontal line is the tolerance factor T.

TABLE 1

| | | | Initial | Hydro- |
|---|---|---|---|---|
| | | Toler- | Performance | thermal |
| | | ance | Value | Decompo- |
| | Electrolyte | Factor | (A/cm²) | sition |
| Comparative | BaCe_{0.8}Nd_{0.2}O₃ | 0.929 | 1.57 | yes |
| Example 1 | | | | |
| Comparative | BaCe_{0.8}Y_{0.2}O₃ | 0.935 | 1.50 | yes |
| Example 2 | | | | |
| Example 1 | SrZr_{0.8}In_{0.2}O₃ | 0.940 | 0.99 | no |
| Example 2 | BaCe_{0.4}Zr_{0.4}Y_{0.2}O₃ | 0.960 | 1.44 | no |
| Example 3 | BaCe_{0.4}Zr_{0.4}In_{0.2}O₃ | 0.969 | 0.99 | no |
| Example 4 | BaZr_{0.8}Y_{0.2}O₃ | 0.987 | 0.42 | no |
| Example 5 | BaZr_{0.8}In_{0.2}O₃ | 0.996 | 0.68 | no |
| Comparative | BaZr_{0.8}Ni_{0.2}O₃ | 1.019 | 0 | no |
| Example 3 | | | | |

As shown in Table 1, hydrothermal decomposition was observed in the fuel cell according to the comparative example 1 or 2. This was attributed to the fact that the tolerance factors T of the electrolyte membranes according to the comparative examples 1 and 2 were smaller than the values defined by the expression (2). In other words, it was assumed that the hydrothermal decomposition occurred because more distortions occurred in the electrolyte membranes according to the comparative examples 1 and 2. On the other hand, no hydrothermal decomposition was observed in each electrolyte membrane which had the tolerance factor T equal to or higher than 0.940. According to the above, it was demonstrated that tolerance factor T should be equal to or higher than 0.940, to suppress the hydrothermal decomposition.

Further, as shown in Table 1 and FIG. 2, when the tolerance factor T exceeded 0.996, like the comparative example 3, the initial performance value was zero (0). On the other hand, when the tolerance factor T was equal to or lower than 0.996, the initial performance value was equal to or higher than 0.4 A/cm². Accordingly, it was demonstrated that, in order to achieve a good initial performance value, the tolerance factor T should be equal to or lower than 0.996 so that a certain degree of distortion occurred in the electrolyte membrane.

According to the above, when the tolerance factor T is equal to or higher than 0.940 and is equal to or less than 0.996, it is demonstrated that the hydrothermal decomposition of the electrolyte membrane can be suppressed and high electricity generation efficiency can be realized.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

1. A fuel cell comprising:
a hydrogen separation membrane;
an electrolyte membrane, provided on the hydrogen separation membrane, that has a proton conductivity and includes a perovskite type electrolyte having a A₁₋ₓA′ₓB_{1-y-z}B′_{y}B″_{z}O₃ structure; and
a cathode provided on the electrolyte membrane,
wherein the tolerance factor T of the perovskite type electrolyte satisfies:
0.940≦T≦0.996.

2. The fuel cell according to claim 1, wherein an initial performance value, which is a current density when the power voltage is equal to 0.5V at an initial stage of electricity generation of the fuel cell, is equal to or higher than 0.4 A/cm².

3. The fuel cell according to claim 1, wherein an operating temperature of the fuel cell is equal to or higher than 300° C. and is equal to or lower than 600° C.

4. The fuel cell according to claim 1, wherein the A is barium and B is cerium.

5. The fuel cell according to claim 1, further comprising
a fuel gas passage that supplies fuel gas to the hydrogen separation membrane; and
an oxidant gas passage that supplies oxidant gas to the cathode.

6. The fuel cell according to claim 5, further comprising first and second separators between which the hydrogen separation membrane, the electrolyte membrane and the cathode are interposed, wherein the fuel gas passage and the oxidant gas passage are respectively provided in the first and second separators.
